(19) United States
(12) Patent Application Publication
(10) Pub. No.: US 2015/0015576 A1
(43) Pub. Date: Jan. 15, 2015

(54) OBJECT RECOGNITION AND VISUALIZATION

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 13/938,358

(22) Filed: Jul. 10, 2013

(51) Int. Cl. G06K 9/00; G06T 17/10

(52) U.S. Cl. CPC G06K 9/00208; G06T 17/10
USPC 345/420

(57) ABSTRACT

A method is disclosed for identifying and presenting a 3D model for an object appearing in a picture or image. The method is used with pictures in printed materials such as books, newspapers, magazines and also used with images presented on a display of a computer, tablet, mobile phone or the like. Furthermore, the method is used for identifying and visualizing buildings, vehicles or other objects located indoors or outdoors while using one of the modern head mounted computer displays or glasses known commercially as wearable devices.

### CROSS-REFERENCE TO RELATED APPLICATION

This application is a Continuation-in-Part of co-pending U.S. patent application Ser. No. 12/462,715, filed Aug. 7, 2009, titled “Converting a drawing into multiple matrices”, and Ser. No. 16/271,892, filed Jul. 10, 2013, titled “Object recognition for 3D models and 2D drawings”.

### BACKGROUND

When a human looks at an object in a picture or a video sequence, s/he recognizes two pieces of information about the object. The first piece of information is the identity of the object and the second piece of information is the spatial aspects of the object. For example, when someone sees a picture of a car, s/he does not only recognize the car in the picture, but envisions the three-dimensional (3D) shape of the car s/he is seeing, irrespective of the parts of the car that the images may not show. In other words, recognizing and visualizing objects in pictures are two simultaneous processes that human brains perform with little effort. This is despite the fact that humans recognize and visualize objects that are seen from different points-of-view or even if the objects have a set of different details or appearance.

In computer vision, some algorithms and techniques enable recognizing some objects such as vehicles, buildings, animals, or humans, but no algorithm or technique—so far—enables recognizing and visualizing objects simultaneously. In fact, there is a need for a universal solution that achieves simultaneous recognition and visualization for objects similar to what the human brain does. This universal solution will open the door for numerous educational, gaming, medical, engineering and industrial applications.

### SUMMARY

The present invention introduces a method for recognizing and visualizing objects in images and video sequences. Accordingly, it becomes possible to partially view an object using a device camera and see the object's name presented on the device display with a 3D model for the object. The user can then rotate or walk through the 3D model on the device display to view the hidden parts of the object that are not seen from the user's point-of-view. Generally, the method of the present invention is used with pictures of printed materials such as books, newspapers and magazines. It can also be used with images presented on a display of a computer, tablet, mobile phone or the like. Furthermore, the method is used for identifying and visualizing buildings, vehicles, or other objects located indoors or outdoors while using one of the modern head mounted computer displays or glasses known commercially as wearable devices.

In one embodiment, the present invention discloses a method for identifying and visualizing a 3D model of an object presented in a picture. This method is comprised of four steps: first, creating a 3D model for the object according to a vector graphic format then rotating the 3D model horizontally and vertically in front of a virtual camera to store each image of the 3D model during each rotation; second, analyzing each image's parameters—including the number of two-dimensional (2D) shapes contained in the image, the identities of the 2D shapes and the attachment relationship between the 2D shapes—to create a list of unique images with unique parameters; third, detecting the edges of the object in the picture and analyzing the edge parameters including the number of 2D shapes contained in the edges, the identity of the 2D shapes and the attachment relationship between the 2D shapes; fourth, checking the edge parameters against the list of unique images to determine if the edge parameters match any of the images in the list and then displaying the object's name and its corresponding 3D model.

In another embodiment, the present invention discloses a method for determining a point-of-view of a camera relative to an object as it appears in a picture taken by said camera to present a 3D model for the object according to the point-of-view. This method is comprised of four steps: first, creating a 3D model for the object according to a vector graphic format then rotating the 3D model horizontally and vertically in front of a virtual camera to store each image of the 3D model associated with each unique camera position; second, analyzing each image parameter—including the number of 2D shapes contained in the image, the identities of the 2D shapes and the attachment relationship between the 2D shapes—and creating a list of unique images with their correspondingly unique parameters; third, detecting the edges of the object in the picture and analyzing the edge parameters including the number of 2D shapes of the edges, the identities of the 2D shapes and the attachment relationship between the 2D shapes; fourth, checking the edge parameters against the list of the unique images to find the image(s) with parameters that match the edge parameters and then displaying the 3D model according to the camera position associated with the image.

### BRIEF DESCRIPTION OF THE DRAWINGS

FIGS. 1 to 6 illustrate six pictures of a cube taken from different points-of-view.

FIG. 7 illustrates a table describing the 2D shapes that appear in each picture of the six pictures.

FIG. 8 illustrates a circle sliced with a plurality of rays creating a number of intersectional lines.

FIG. 9 illustrates a table indicating the pattern of the intersectional lines of the circle.

FIG. 10 illustrates a graph representing the length variations of the intersectional lines relative to each other.

FIG. 11 illustrates a parallelogram sliced with a plurality of rays creating a number of intersectional lines.

FIG. 12 illustrates a table indicating the pattern of the intersectional lines of the parallelogram.

FIG. 13 illustrates a graph representing the length variations of the intersectional lines relative to each other.

FIG. 14 illustrates a table indicating the patterns of the intersectional lines of some individual 2D shapes.

FIG. 15 illustrates an example of combined 2D shapes in the form of an L-shape.

FIG. 16 illustrates dividing the L-shape into two individual 2D shapes or rectangles.

FIG. 17 illustrates tagging each corner of the two rectangles with an ID.

FIG. 18 illustrates an example for describing the attachment between the two rectangles.

FIG. 19 illustrates another example of combined 2D shapes.

FIG. 20 illustrates dividing the combined 2D shape into four individual 2D shapes.

FIG. 21 illustrates tagging each corner of the four individual 2D shapes with an ID.

FIG. 22 illustrates an example for describing the attachment between the four individual 2D shapes.

FIG. 23 illustrates a picture of a 3D object where its edges form seven individual 2D shapes.

FIG. 24 illustrates a picture of a 3D object where its edges form four individual 2D shapes and two combined 2D shapes.

FIGS. 25 and 26 illustrate each of the two combined 2D shapes divided into two individual 2D shapes.

### DETAILED DESCRIPTION

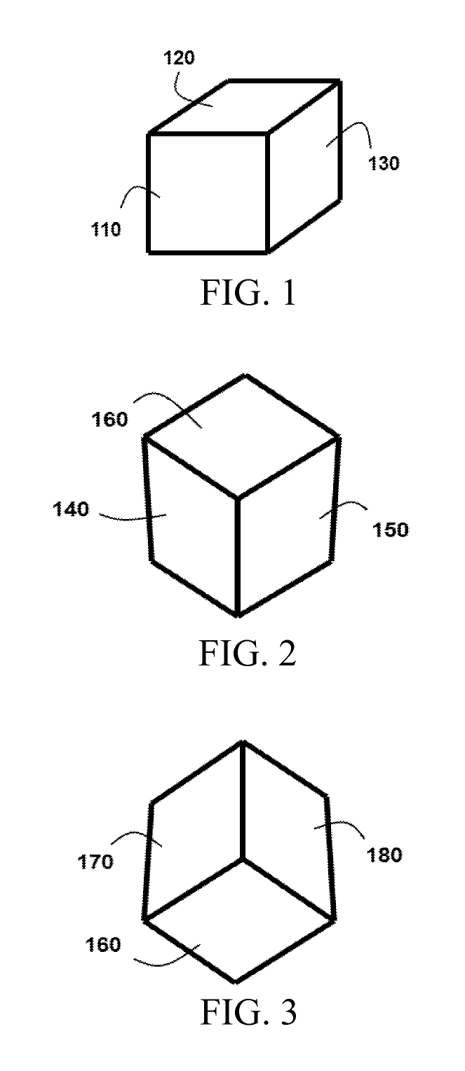

FIG. 1 illustrates an image of a 3D model of a cube viewed from a point-of-view where the cube edges form a square 110, a first parallelogram 120 and a second parallelogram 130. Rotating the 3D model of the cube horizontally and vertically in front of a virtual camera creates different images that form different 2D shapes. For example, FIG. 2 illustrates an image of the cube where the cube edges form a first parallelogram 140, a second parallelogram 150 and a diamond 160. In this image, the virtual camera appears to be located at a higher level than the cube height showing three faces of the cube. FIG. 3 illustrates another image of the cube where the cube edges form a diamond 170, a first parallelogram 160 and a second parallelogram 180. In this image, the virtual camera appears to be located at a lower level than the cube base showing three faces of the cube.

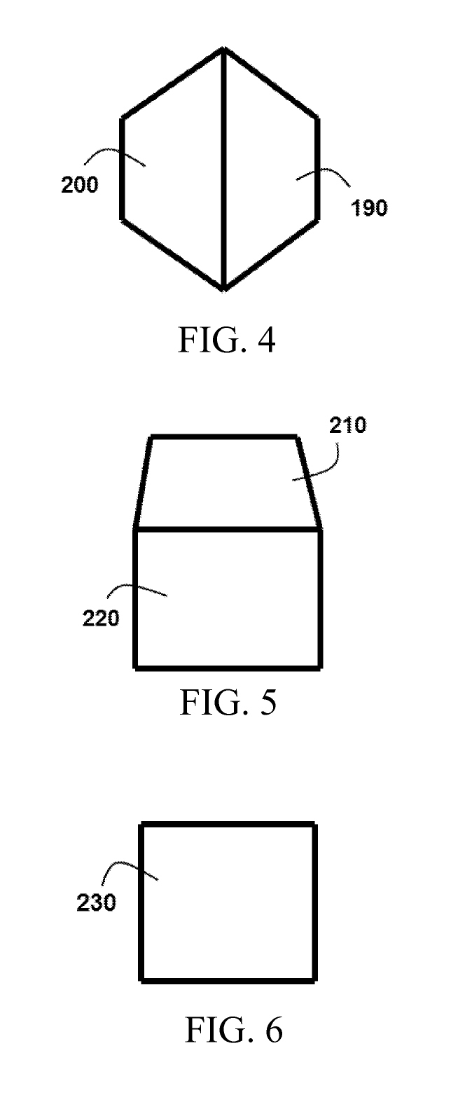

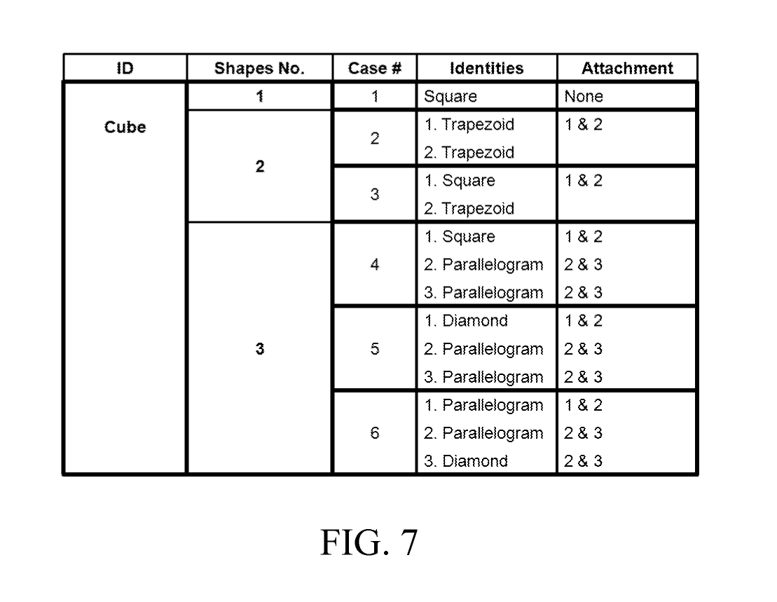

FIG. 4 illustrates another image of the cube where the cube edges form a first trapezoid 190 and a second trapezoid 200. In this image, the virtual camera is positioned near the middle of the cube height showing two faces of the cube. FIG. 5 illustrates an image of the cube where the cube edges form a square 210 and a trapezoid 220. FIG. 6 illustrates another image of the cube where the cube edges form a square 230 representing one face of the cube where the virtual camera is directly positioned in front of this face. FIG. 7 illustrates a table representing a database describing the 2D shapes contained in each image of the six images of the cube. According to this database, an object in an image is identified as a cube if the cube edges form or contain 2D shapes according to one of the six cases indicated in the table. The first case includes a square. The second case includes two trapezoids attached to each other. The third case includes a square and a trapezoid attached to each other. The fourth case includes a square and two parallelograms attached to each other. The fifth case includes a diamond and two parallelograms attached to each other. The sixth case includes two parallelograms and a diamond attached to each other.

Generally, an object in an image is identified as a cube if the object's edges in the image form one or more 2D shapes attached to each other according to one of the alternatives of the previous database. However, if the object's image or picture is taken by a digital camera, then an edge detection program is utilized, as known in the art, to detect the edges of the 2D shapes that the object is comprised in the picture. After that, each 2D shape in the object's image is analyzed to determine its identity. Also, the attachment relationship between the 2D shapes is defined or described. At this moment, the number of the 2D shapes, the identities of the 2D shapes and the attachment relationship between the 2D shapes are checked against a database that assigns an ID or name for each unique combination of a number of 2D shapes, identities of 2D shapes and attachment relationship between 2D shapes. However, as was described previously, the database can be automatically created by rotating a 3D model for the object in front of a virtual camera to capture the object's images from different points-of-view and create a list of all unique combinations of 2D shapes, identities of 2D shapes and attachment relationships between the 2D shapes that appear in an image. Once the object is defined using the database then the object's name and the 3D model of the object, which is stored with the database content, are presented to the user.

In one embodiment, the present invention discloses a method for identifying and visualizing a 3D model of an object presented in a picture. This method is comprised of four steps: first, creating a 3D model for the object according to a vector graphic format then rotating the 3D model horizontally and vertically in front of a virtual camera to store each image of the 3D model during each rotation; second, analyzing each image's parameters—including the number of 2D shapes contained in the image, the identities of the 2D shapes and the attachment relationship between the 2D shapes—to create a list of unique images with unique parameters; third, detecting the edges of the object in the picture and analyzing the edge parameters including the number of 2D shapes contained in the edges, the identity of the 2D shapes and the attachment relationship between the 2D shapes; fourth, checking the edge parameters against the list of unique images to determine if the edge parameters match any of the images in the list and then displaying the object's name and its corresponding 3D model.

It is important to note that during the rotation of the virtual 3D model of the object in front of the virtual camera, the position of the camera relative to the virtual 3D model can be determined and stored. Accordingly, each unique combination of a number of 2D shapes, identities of the 2D shapes and attachment relationship between the 2D shapes is assigned with a corresponding position for the virtual camera. This way, when taking an object's picture by a digital camera and analyzing the object's edges or 2D shapes, the result of this analysis indicates the position of the digital camera relative to the object at the moment of taking the picture. Accordingly, the 3D model of the object is presented to the user on the camera display to match his/her position relative to the object. In this case, the user may interact with the 3D model on the camera display to rotate it vertically or horizontally, or to walk though the 3D model to see more interior details.

In another embodiment, the present invention discloses a method for determining a point-of-view of a camera relative to an object as it appears in a picture taken by said camera to present a 3D model for the object according to the point-of-view. This method is comprised of four steps: first, creating a 3D model for the object according to a vector graphic format then rotating the 3D model horizontally and vertically in front of a virtual camera to store each image of the 3D model associated with each unique camera position; second, analyzing each image parameter—including the number of 2D shapes contained in the image, the identities of the 2D shapes and the attachment relationship between the 2D shapes—and creating a list of unique images with their correspondingly unique parameters; third, detecting the edges of the object in the picture and analyzing the edge parameters including the number of 2D shapes of the edges, the identities of the 2D shapes and the attachment relationship between the 2D shapes; fourth, checking the edge parameters against the list of the unique images to find the image(s) with parameters that match the edge parameters and then displaying the 3D model according to the camera position associated with the image.

It is important to note that the slight difference of the virtual camera position relative to the virtual 3D object may not lead to a different combination of a number of 2D shapes, identities of 2D shapes and attachment relationships between the 2D shapes. However, the relative dimensions of the 2D shapes will vary from slight changes in position of a virtual camera, whereas storing the dimensions of the 2D shapes of each image leads to determining the exact position of the virtual camera. Accordingly, in this case, the list of unique images will include all images that have similar parameters but with different 2D shape dimensions.

Generally, the 2D shapes that result from analyzing the object's edges in the images or picture can be classified into individual 2D shapes and combined 2D shapes. The individual 2D shapes are the 2D shapes that have a simple form such as a circle, rectangle, triangle or parallelogram. The combined 2D shapes are the 2D shapes that are comprised of a plurality of individual 2D shapes attached to each other in a certain manner to form one entity. For example, the L-shape is a combined 2D shape comprised of two individual 2D shapes in the form of two rectangles attached to each other. Also the U-shape is a combined 2D shape comprised of three individual 2D shapes in the form of three rectangles attached to each other.

To identify an individual 2D shape, five steps are processed. The first step is slicing the individual 2D shape with a plurality of rays creating a number of intersectional lines. The second step is determining the axis pattern that describes a path connecting between the middles of the successive intersectional lines. The third step is determining the shapes pattern that describes the intersectional lines. The fourth step is determining the length pattern that describes the length variations between the intersectional lines. The fifth step is checking the axis pattern, the shape pattern and the length pattern against a database that associates each unique combination of an axis pattern, shape pattern and length pattern with a unique ID identifying a 2D object.

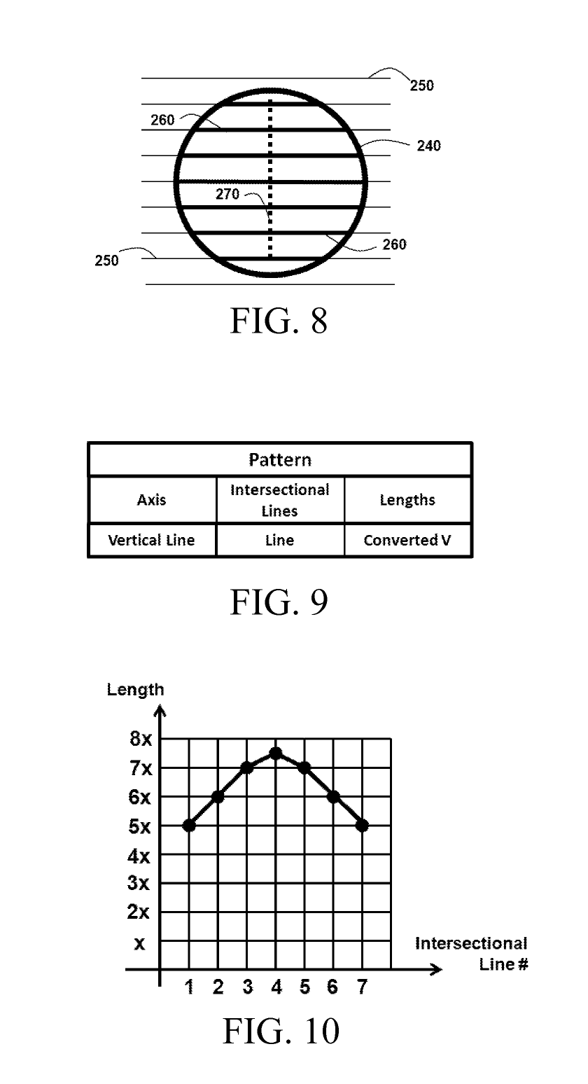

For example, FIG. 8 illustrates a circle 240 sliced with a plurality of parallel rays 250 where the intersection between each ray and the circle creates an intersectional line 260 that starts and ends at the circle's perimeter. Connecting between the center point of each two successive intersectional lines creates an axis 270. FIG. 9 illustrates a table indicating the pattern of the axis, the pattern of the intersectional lines and the pattern of the lengths of the intersectional lines. As shown in the table, the axis pattern is that of a vertical line, the intersectional line pattern is that of a line and the length pattern is that of a “Converted V”. FIG. 10 illustrates a graph representing the relationship between each intersectional line and its length where the shape of the “Converted V” appears in the graph.

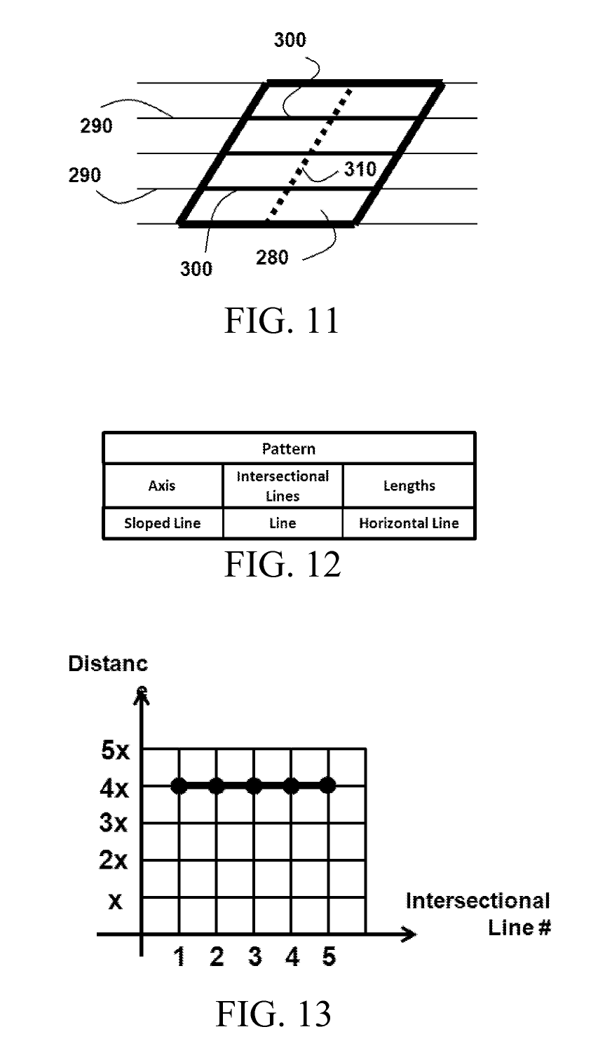

FIG. 11 illustrates another example of an individual 2D shape in the form of a parallelogram 280. As shown in the drawing, the parallelogram is sliced with a plurality of parallel rays 290 where the intersection between each ray and the parallelogram creates an intersectional line 300 that starts and ends at the parallelogram's perimeter. Connecting between the center point of each two successive intersectional lines creates an axis 310. FIG. 12 illustrates a table indicating the axis pattern, the intersectional lines pattern and the length pattern of this process. As shown in the table, the axis pattern is that of a sloped line, the intersectional lines pattern is that of a line and the length pattern is that of a horizontal line. FIG. 13 illustrates a graph representing the relationship between each intersectional line and its length where the horizontal line that represents the length pattern appears in the graph.

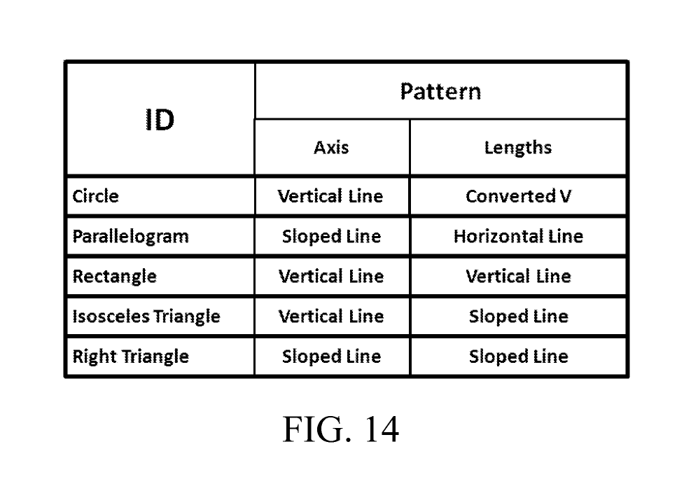

FIG. 14 illustrates an example of a database that associates a unique name or ID for a circle, parallelogram, rectangle, isosceles triangle and right triangle. As shown in the figure, each one of the individual 2D objects is associated with a unique combination of an axis pattern, an intersectional lines pattern and a length pattern. According to this database, the shape of FIG. 8 is automatically identified as a circle. Also the shape of FIG. 11 is automatically identified as a parallelogram. In a similar manner, a rectangle, an isosceles triangle or a right triangle can be automatically recognized or identified using this database.

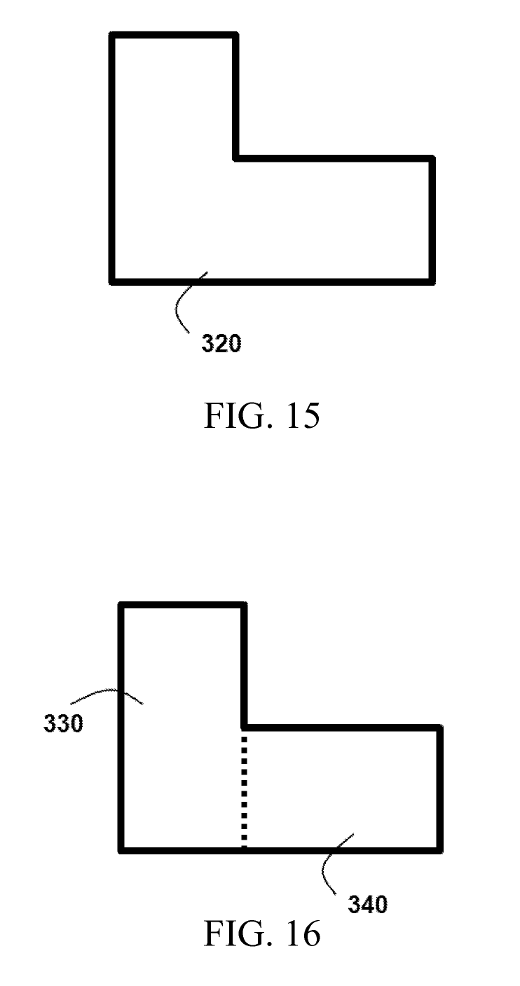

To identify a combined 2D shape, the combined 2D shape is divided into a plurality of individual 2D shapes where each individual 2D shape is identified alongside the attachment relationship between the individual 2D shapes. Comparing the identities of the individual 2D shapes and their attachment relationship against a database that associates a unique ID for each unique combination of 2D shapes, identities and attachment relationships enables identifying the combined 2D shapes. For example, FIG. 15 illustrates a combined 2D shape 320 in the form of an L-shape that can be divided into a first rectangle 330 and a second rectangle 340 as illustrated in FIG. 16.

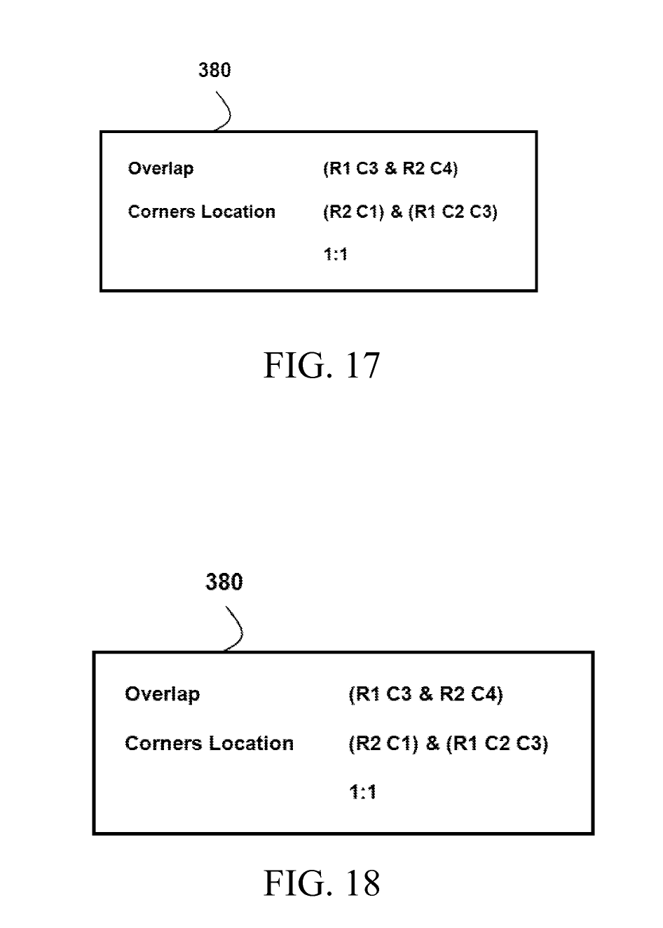

FIG. 17 illustrates tagging each corner of a rectangle with an ID representing its order starting with the top-left corner. As shown in the figure, the first rectangle, which is symbolized with “R1”, has its corners successively tagged with C1, C2, C3 and C4 starting with the top-left corner 360. Also, the second rectangle, which is symbolized with “R2”, has its corners successively tagged with C1, C2, C3 and C4 starting with the top-left corner 370. FIG. 18 illustrates a script 380 describing the attachment relationship between the two rectangles. As shown in the figure, the first line of the script indicates the overlap between the corners of the two rectangles, whereas the third corner “C3” of the first rectangle “R1” is overlapping with the fourth corner “C4” of the second rectangle “R2”. The second line of the script indicates the corner locations for the overlapped lines. As shown in the figure, the first corner “C1” of the second rectangle “R2” is located between the second corner “C2” and the third corner “C3” of the first rectangle “R1”. The third line in the script indicates the ratio of dividing the overlapping lines. As shown in the figure, the first corner of the second rectangle “R2 C1” is located on equal distances from the second and third corners of the first rectangle “R1 C2C3”, where this relation is expressed by the ratio “1:1”. Generally, the script may include more detailed data such as the lengths of all lines of individual 2D shapes relative to each other, or the like.

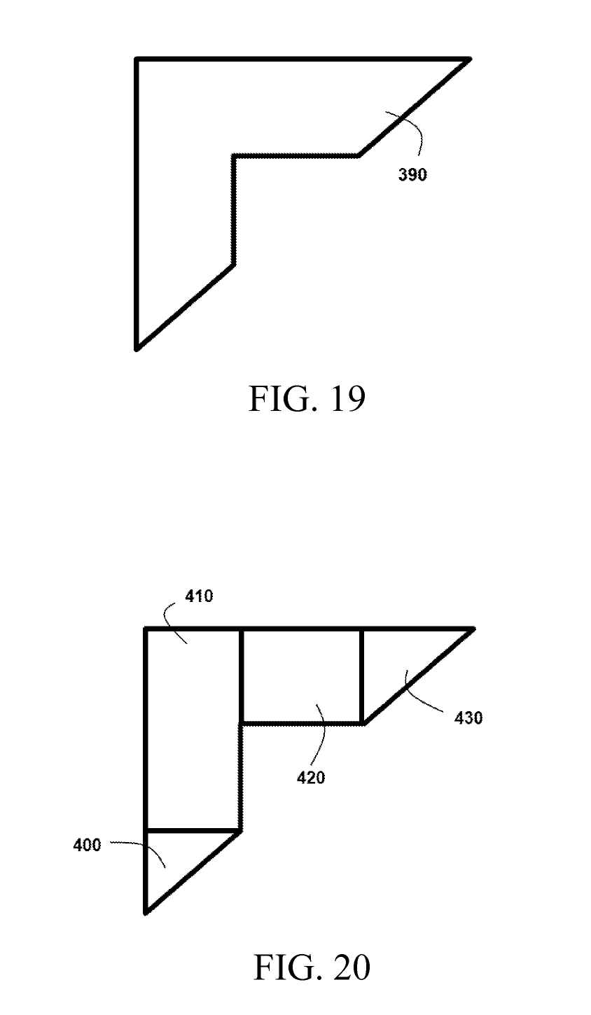

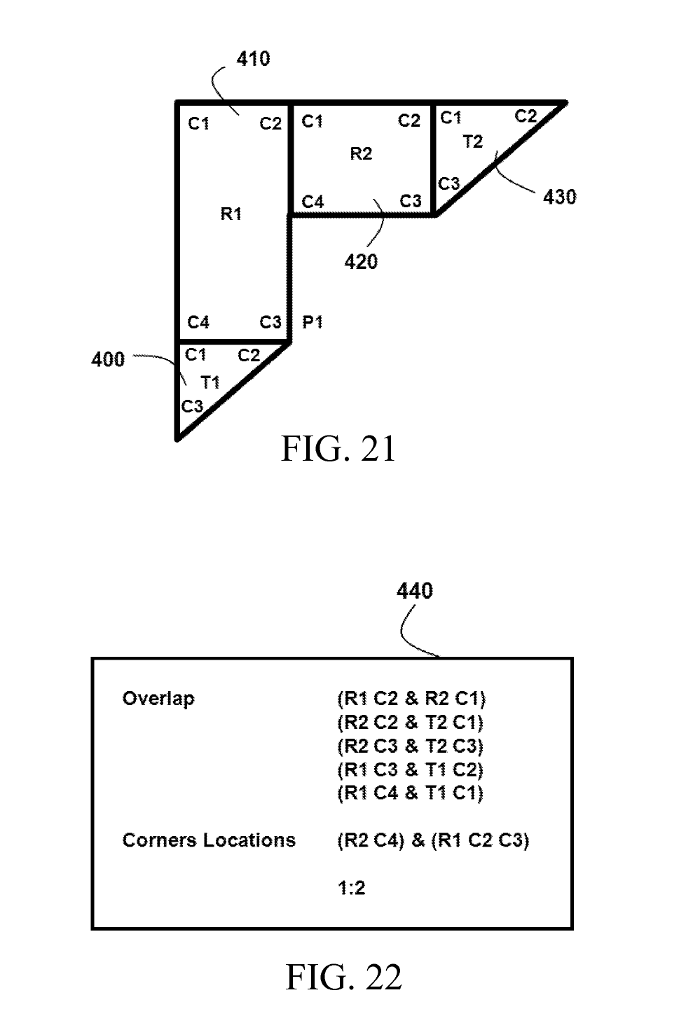

FIG. 19 illustrates another example of combined 2D shapes 390. FIG. 20 illustrates dividing this combined 2D shape into a number of individual 2D shapes in the form of a first triangle 400, a first rectangle 410, a second rectangle 420 and a second triangle 430. FIG. 21 illustrates tagging the corners of each individual 2D shape with an ID representing its order starting from the top-left corner of the individual 2D shape. In this figure, the first triangle, the first rectangle, the second rectangle and the second triangle are respectively tagged with “T1”, “R1”, “R2” and “T2”. FIG. 22 illustrates the script 440 that describes the attachment relationships between the individual 2D shapes of this example.

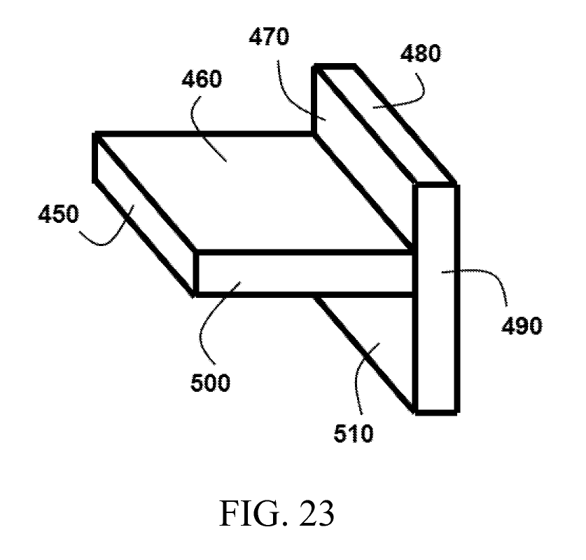

FIG. 23 illustrates an example of a picture taken for a 3D object. As shown in the figure, the edges of the 3D object contain seven individual 2D shapes in the form of four parallelograms 450-480, two rectangles 490-500, and a triangle 510. Identifying each individual 2D shape and the attachment relationships between them, followed by comparing this information with a database that associates each unique combination of individual 2D shapes and attachment relationships with a unique ID enables identifying this 3D object.

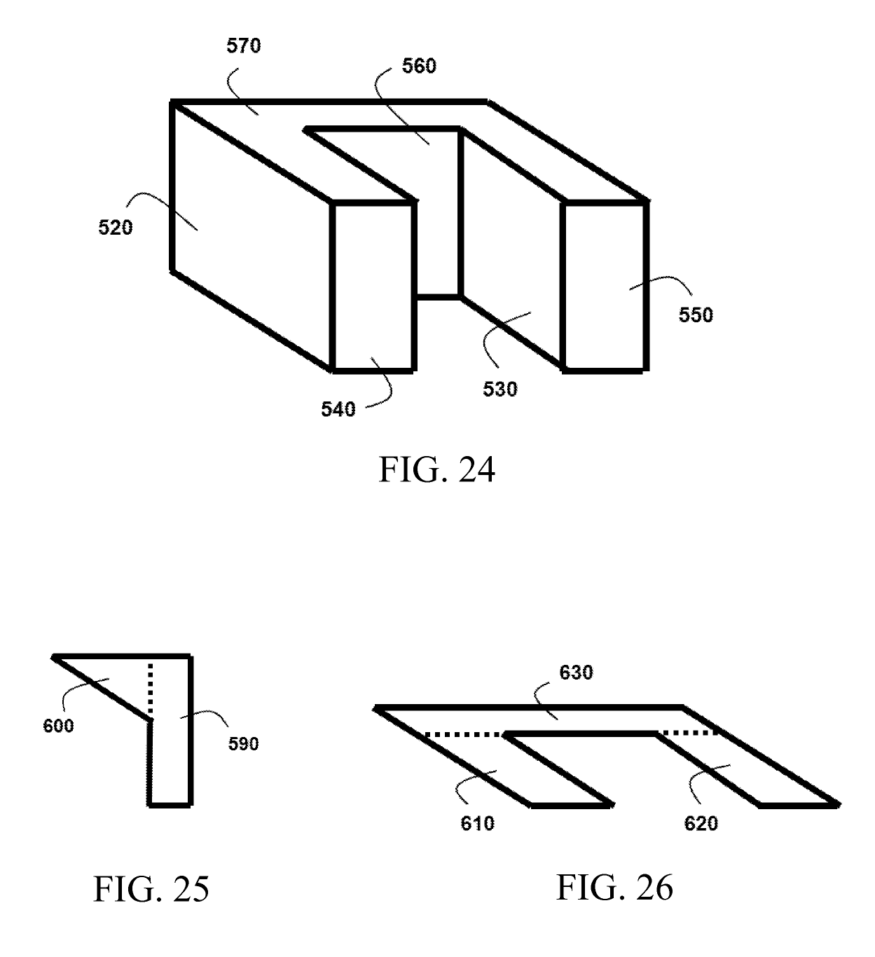

FIG. 24 illustrates an example of a picture taken for a 3D object. As shown in the figure, the edges of the 3D object contain four individual 2D shapes and two combined 2D shapes. The four individual 2D shapes are in the form of two parallelograms 520-530 and two rectangles 540-550. The two combined 2D shapes 560 and 570 can be divided into a number of individual 2D shapes. For example, FIG. 25 illustrates dividing the first combined 2D shape 560 into a rectangle 590 and a triangle 600. FIG. 26 illustrates dividing the second combined 2D shape 570 into a first parallelogram 610, a second parallelogram 620, and a third parallelogram 630. Identifying each individual 2D shape and each combined 2D shape, and describing the attachment relationships between them then comparing this information with a database that associates each unique combination of individual and/or combined 2D shapes and attachment relationships with a unique ID enables identifying this 3D object.

Finally, the 3D models described in the previous examples are represented according to a vector graphics format. However, in cases where 3D models are represented by a set of points using the point cloud technique, in this case, the set of points are converted into a plurality of triangles represented according to the vector graphics format, as known in the art, where then the method of the present invention can be utilized with the triangles. Also, if the 3D model is represented according to a raster graphics format, then an edge detection program is utilized, as known in the art, to detect the edges of the 3D model and convert them into lines where each two lines that meet at one point are converted into a triangle. Accordingly, the 3D model can be represented by a plurality of triangles according to a vector graphics format where then the method of the present invention can be utilized with these triangles.

1. A method for identifying and presenting a 3D model for an object that appears in a picture wherein the method is comprised of:
creating a 3D model for the object according to a vector graphic format then rotating the 3D model horizontally and vertically in front of a virtual camera to store each image of the 3D model at each different rotation;
analyzing each image parameter, including the number of 2D shapes contained in the image, the identities of the 2D shapes and the attachment relationships between the 2D shapes, to create a list of unique images that have unique parameters;
detecting the edges of the object in the picture and analyzing the edge parameters including the number of 2D shapes contained in the edges, the identity of the 2D shapes and the attachment relationships between the 2D shapes; and
checking the edge parameters against the list of unique images to determine if the edge parameters match the parameters of one image of the list of unique images and then displaying the object's name and its corresponding 3D model.

2. The method of claim 1 wherein said picture is taken by a camera of a device and said object's name and said 3D model are presented on the display of said device.

3. The method of claim 1 wherein said 2D shapes are simple geometrical shapes such as triangles, rectangles, parallelograms or circles.

4. The method of claim 1 wherein one or more of said 2D shapes are comprised of a plurality of simple geometrical shapes attached to each other.

5. The method of claim 1 wherein said edges are detected by an edge detection program.

6. The method of claim 1 wherein said 3D model is represented by a set of points using the point cloud technique and converted into a plurality of triangles represented according to a vector graphics format.

7. The method of claim 1 wherein said 3D model is represented by a plurality of pixels according to a raster graphics format and converted into a plurality of polygons represented according to a vector graphics format.

8. The method of claim 1 wherein said identities of said 2D shapes are obtained from a database that associates each unique parameter of a 2D shape with a unique ID.

9. The method of claim 1 wherein said attachment relationship includes: a list of said 2D shapes that are attached to each other; the lines of said 2D shapes that are overlapping with each other; and the relative lengths of said lines.

10. The method of claim 2 wherein a user can interact with said 3D model on said display.

11. A method for determining a point-of-view of a camera relative to an object that appears in a picture taken by the camera to present a 3D model for the object according to the point-of-view wherein the method is comprised of:
creating a 3D model for the object according to a vector graphics format then rotating the 3D model horizontally and vertically in front of a virtual camera to store each image of the 3D model associated with a unique camera position;
analyzing each image parameter including the number of 2D shapes contained in the image, the identities of 2D shapes, and the attachment relationships between the 2D shapes to create a list of unique images that have unique parameters;
detecting the edges of the object in the picture and analyzing the edge parameters including the number of 2D shapes of the edges, the identities of 2D shapes and the attachment relationships between the 2D shapes; and
checking the edge parameters against the list of unique images to find the image(s) with parameters that match the edge parameters and then displaying the 3D model according to the unique camera position associated with the image.

12. The method of claim 11 wherein said picture is taken by a camera of a device and said 3D model is presented on the display of said device.

13. The method of claim 1 wherein said 2D shapes are simple geometrical shapes such as triangles, rectangles, parallelograms or circles.

14. The method of claim 1 wherein one or more of said 2D shapes are comprised of a plurality of simple geometrical shapes attached to each other.

15. The method of claim 1 wherein said edges are detected by an edge detection program.

16. The method of claim 1 wherein said 3D model is represented by a set of points using the point cloud technique and converted into a plurality of triangles represented according to a vector graphics format.

17. The method of claim 1 wherein said 3D model is represented by a plurality of pixels according to a raster graphics format and converted into a plurality of polygons represented according to a vector graphics format.

18. The method of claim 1 wherein said identities of said 2D shapes are obtained from a database that associates each unique parameter of a 2D shape with a unique ID.

19. The method of claim 1 wherein said attachment relationships include: a list of said 2D shapes that are attached to each other; the lines of said 2D shapes that are overlapping with each other; and the relative lengths of said lines.

20. The method of claim 12 wherein a user can interact with said 3D model on said display.
